(19) United States
(12) Patent Application Publication
(10) Pub. No.: US 2018/0060984 A1
(43) Pub. Date: Mar. 1, 2018

(54) METHOD AND SYSTEM FOR CONTENT PROCESSING TO DETERMINE PRE-REQUISITE SUBJECT MATTERS IN MULTIMEDIA CONTENT

(71) Applicant: YEN4KEN, INC., Princeton, NJ (US)

(72) Inventors: Ankit Gandhi, Raipur (IN); Arijit Biswas, Kolkata (IN); Om D. Deshmukh, Bangalore (IN); Sahil Loomba, Ghaziabad (IN)

(21) Appl. No.: 15/250,958

(22) Filed: Aug. 30, 2016

(51) Int. Cl. G06Q 50/20; G06F 17/30

(52) U.S. Cl. CPC G06Q 50/205; G06F 17/30035; G06F 17/3053

(57) ABSTRACT

A method and a system are provided for content processing to determine pre-requisite subject matters for subject matters in multimedia content. The method determines a set of pre-requisite concepts and a set of outcome concepts for each of a set of multimedia content of a course. The method determines a concept coverage score based on at least the determined set of pre-requisite concepts and the determined set of outcome concepts. The method further determines a relevance score of each pre-requisite concept that corresponds to the set of pre-requisite concepts. The method further determines a weighted score for one of the first set of multimedia content based on the determined concept coverage score and the determined relevance score of one or more of the set of pre-requisite concepts. Further, the method determines a set of pre-requisite subject matters for the subject matters based on at least the determined weighted score.

### TECHNICAL FIELD

The presently disclosed embodiments are related, in general, to multimedia content processing. More particularly, the presently disclosed embodiments are related to method and system for content processing to determine pre-requisite subject matters in multimedia content.

### BACKGROUND

The ever increasing advancements in the field of education have led to the usage of Massive Open Online Courses (MOOCs) as one of the popular modes of learning. Several educational organizations, such as Stanford, Harvard, Massachusetts Institute of Technology (MIT), Yale, and Indian Institute of technology (IIT), are making thousands of hours of video lectures that may be available online and free of cost to students for learning purposes. As the amount and demand for these online lecture videos is increasing across the world, it may be essential to develop methods for efficient consumption of these online lecture videos.

The courses offered by MOOCs comprise multiple lecture videos per course. For example, the courses, provided by National Program on Technology Enhanced Learning (NPTEL), have an average of “30” lecture videos per course of an hour each. Further, the lecture videos are in a pedagogical order, which the students may have to follow to finish up the courses. For example, if a student is undertaking a course, then the student may have to watch the lecture videos of the course in the pedagogical order (e.g., lecture-1, lecture-2, lecture-3, . . . , lecture-n), as defined by MOOC provider or lecturer to finish the course. There is no relaxed ordering of the lecture videos in the course, for example, if one or more concepts discussed in “lecture-i” and “lecture-j” are not related, then they may be watched in any order. Further, if the student is interested in a particular lecture of the course, then there is no information available about other lecture videos or parts of lecture videos that may be essential to understand i.e., no pre-requisite information is available for the particular lecture video. The one solution to such problem is to consider all such previous lecture videos as pre-requisite for the lecture video. However, such a solution may be very unrealistic and impractical, especially for informal learners who, in general, access these video lectures for very specific and varied subject matters. In another solution, an individual, such as a subject matter expert, may manually go through each lecture video, and thereafter may create a list of pre-requisites for each lecture video and each subject matter or concept in each lecture video. However, such manual actions for thousands of videos spanning over multiple courses may be an arduous task. Thus, there is required a method and a system for efficient and effective consumption of these online lecture videos by individuals, such as the students.

Further limitations and disadvantages of conventional and traditional approaches will become apparent to a person having ordinary skill in the art, through a comparison of described system with some aspects of the present disclosure, as set forth in the remainder of the present application and with reference to the drawings.

### SUMMARY

According to embodiments illustrated herein, there may be provided a method for content processing to determine pre-requisite subject matters from a first set of multimedia content for a subject matter in a second set of multimedia content. The method may comprise determining, by a processor, a set of pre-requisite concepts and a set of outcome concepts for each of a set of multimedia content of a course based on at least one or more concepts extracted from each of the set of multimedia content. In an embodiment, the set of multimedia content comprise at least the first set of multimedia content and the second set of multimedia content. The method may further comprise determining, by a score generating processor, a concept coverage score based on at least the determined set of pre-requisite concepts associated with the second multimedia content and the determined set of outcome concepts associated with at least one of the first set of multimedia content. The method may further comprise determining, by the score generating processor, a relevance score of each pre-requisite concept that corresponds to the set of pre-requisite concepts based on at least a frequency of occurrence of each pre-requisite concept in the second multimedia content. The method may further comprise determining, by the score generating processor, a weighted score for at least the one of the first set of multimedia content based on the determined concept coverage score of the second multimedia content and the determined relevance score of one or more of the set of pre-requisite concepts of the second multimedia content. The method may further comprise determining, by the processor, a set of pre-requisite subject matters for the subject matters in the second multimedia content based on at least the determined weighted score associated with at least one of the first set of multimedia content.

According to embodiments illustrated herein, there may be provided a system for content processing to determine pre-requisite subject matters from a first set of multimedia content for a subject matter in a second set of multimedia content. The system may comprise a processor configured to determine a set of pre-requisite concepts and a set of outcome concepts for each of a set of multimedia content of a course based on at least one or more concepts extracted from each of the set of multimedia content. Further, the set of multimedia content comprise at least the first set of multimedia content and the second set of multimedia content. The system may further comprise a score generating processor configured to determine a concept coverage score based on at least the determined set of pre-requisite concepts associated with the second multimedia content and the determined set of outcome concepts associated with at least one of the first set of multimedia content for a second multimedia content. The score generating processor may be further configured to determine a relevance score of each pre-requisite concept that corresponds to the set of pre-requisite concepts based on at least a frequency of occurrence of each pre-requisite concept in the second multimedia content. Further, the score generating processor may determine a weighted score for at least the one of the first set of multimedia content based on the determined concept coverage score of the second multimedia content and the determined relevance score of one or more of the set of pre-requisite concepts of the second multimedia content. Further, the processor may be configured to determine a set of pre-requisite subject matters for the subject matter in the second multimedia content based on at least the determined weighted score associated with at least one of the first set of multimedia content.

According to embodiments illustrated herein, there is provided a computer program product for use with a computer, the computer program product comprising a non-transitory computer readable medium, wherein the non-transitory computer readable medium stores a computer program code for content processing to determine pre-requisite subject matters from a first set of multimedia content for a subject matter in a second set of multimedia content. The computer program code is executable by one or more processors to determine a set of pre-requisite concepts and a set of outcome concepts for each of a set of multimedia content of a course based on at least one or more concepts extracted from each of the set of multimedia content. Further, the set of multimedia content comprise at least the first set of multimedia content and the second set of multimedia content. The computer program code is further executable by one or more processors to determine a concept coverage score based on at least the determined set of pre-requisite concepts associated with the second multimedia content and the determined set of outcome concepts associated with at least one of the first set of multimedia content. The computer program code is further executable by one or more processors to determine a relevance score of each pre-requisite concept that corresponds to the set of pre-requisite concepts based on at least a frequency of occurrence of each pre-requisite concept in the second multimedia content. The computer program code is further executable by one or more processors to determine a weighted score for at least the one of the first set of multimedia content based on the determined concept coverage score of the second multimedia content and the determined relevance score of one or more of the set of pre-requisite concepts of the second multimedia content. The computer program code is further executable by one or more processors to determine a set of pre-requisite subject matters for the subject matters in the second multimedia content based on at least the determined weighted score associated with at least one of the first set of multimedia content.

### BRIEF DESCRIPTION OF DRAWINGS

The accompanying drawings illustrate the various embodiments of a system, method, and other aspects of the disclosure. Any person with ordinary skill in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not limit the scope in any manner, wherein similar designations denote similar elements, and in which:

FIG. 1 is a block diagram that illustrates a system environment in which various embodiments of a method and a system may be implemented, in accordance with at least one embodiment;

FIG. 2 is a block diagram that illustrates a system for content processing to determine pre-requisite subject matters from a first set of multimedia content for a subject matter in a second set of multimedia content, in accordance with at least one embodiment;

FIG. 3 is a flowchart that illustrates a method for content processing to determine pre-requisite subject matters from a first set of multimedia content for a subject matter in a second set of multimedia content, in accordance with at least one embodiment; and

FIG. 4 is a block diagram that illustrates a flow diagram for content processing to determine pre-requisite subject matters from a first set of multimedia content for a subject matter in a second set of multimedia content, in accordance with at least one embodiment.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes, as the method and system may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

A “computing device” refers to a computer, a device (that includes one or more processors/microcontrollers and/or any other electronic components), or a system (that performs one or more operations according to one or more sets of programming instructions, codes, or algorithms) associated with an individual. In an embodiment, the individual may utilize the computing device to transmit his/her one or more preferences to a computing server. Examples of the computing device may include, but are not limited to, a desktop computer, a laptop, a personal digital assistant (PDA), a mobile device, a smartphone, and a tablet computer (e.g., iPad® and Samsung Galaxy The).

“Multimedia content” refers to content that uses a combination of different content forms, such as text content, audio content, image content, animation content, video content, and/or interactive content. In an embodiment, the multimedia content may be reproduced on a computing device through an application, such as a media player (e.g., Windows Media Player®, Adobe® Flash Player, Apple® QuickTime®, and/or the like). In an embodiment, the multimedia content may be downloaded from a server to the computing device. In an alternate embodiment, the multimedia content may be retrieved from a media storage device, such as a hard disk drive (HDD), CD drive, pen drive, and/or the like, connected to (or within) the computing device.

A “course” refers to a series of lectures that are associated with one or more subjects, topics, or domains. For example, the course may correspond to one or more subjects, such as Mathematics, English, Physics, Chemistry, Biology, and/or the like. Further, the course may correspond to one or more topics, such as Newton's laws, electric field, classifiers, compression, decompression, and/or the like. Further, the course may correspond to one or more domains, such as healthcare, education, travel, telecom, and/or the like.

A “set of multimedia content” of a course refers to a series of lectures of the course, such that each lecture in the series of lectures correspond to multimedia content (e.g., an audio content, a video content, an image content, and/or the like). Further, each of the set of multimedia content of the course is arranged in a pedagogical order that defines at least a sequence in which each of the set of multimedia content is to be inferred by a user to complete the course. Further, the set of multimedia content comprises at least a first set of multimedia content and a second set of multimedia content, such that the second set of multimedia content follows after the first set of multimedia content in the set of multimedia content in the pedagogical order.

A “pedagogical order” of a course refers to a defined sequence of a series of lectures (e.g., a series of video or audio lectures) that may be followed in the defined sequence to foster best practices of acquiring, learning, or gaining knowledge about the course.

A “subject matter” refers to a topic associated with a subject or a domain that is being discussed through multimedia content. The subject matter in the multimedia content may have a start time and an end time. In an embodiment, the subject matter may include one or more keywords indicative of properties of the subject matter. For example, the subject matter “probability” may include keywords, such as, but not limited to, likelihood, density, Gaussian, estimation, distribution, and log. In another example, a course on “machine learning” may include various subject matters, such as decision tree, association rule, artificial neural network, inductive logic programming, support vector machine, clustering, and so on.

A “concept” refers to an abstract idea of a subject matter associated with a course. In an embodiment, each of a set of multimedia content of the course may include one or more subject matters and each subject matter may include one or more concepts.

A “set of pre-requisite concepts” of a second multimedia content comprising one or more subject matters of a course refers to a set of concepts in a set of first multimedia content that shall be acquired, learned, or gained knowledge about in advance by a user prior to viewing of the second multimedia content to acquire, learn, or gain knowledge about the one or more subject matters of the course in the second multimedia content. In an embodiment, the set of pre-requisite concepts of the second multimedia content may be determined based on one or more concepts associated with each of the first set of multimedia content. Further, in an embodiment, the set of pre-requisite concepts may be determined by use of one or more external knowledge databases (e.g., Wikipedia®).

A “set of outcome concepts” of multimedia content that corresponds to a set of multimedia content of a course refers to one or more concepts or skills that may have been acquired, learned, or gained knowledge about by a user after viewing the multimedia content. In an embodiment, the set of outcome concepts of the multimedia content may be determined based on one or more concepts associated with one or more multimedia content that correspond to the set of multimedia content of the course. Further, in an embodiment, the set of outcome concepts may be determined by use of one or more external knowledge databases (e.g., Wikipedia®).

A “concept coverage score” refers to a score that is indicative of at least coverage of one or more concepts of a second multimedia content of a course by a first multimedia content of the course. In an embodiment, the concept coverage score is indicative of an amount of pre-requisite concepts of the second multimedia content that are covered by viewing the first multimedia content. In an embodiment, the concept coverage score may be determined based on at least a set of pre-requisite concepts associated with the second multimedia content and a set of outcome concepts associated with the first multimedia content.

A “relevance score” refers to a score that is indicative of at least a relevance or importance of a pre-requisite concept of a second multimedia content of a course that is required to acquire, learn, or gain knowledge about one or more subject matters in the second multimedia content. In an embodiment, the relevance score may be determined based on at least a frequency of occurrence of the pre-requisite concept in the second multimedia content. In an embodiment, the relevance score may further be determined based on at least a frequency of occurrence of each of a set of pre-requisite concepts associated with the second multimedia content.

A “weighted score” of a first multimedia content refers to a score that is indicative of at least an amount of contribution of the first multimedia content in acquiring, learning, or gaining knowledge about one or more subject matters in a second multimedia content. In an embodiment, the weighted score of the first set of multimedia content may be determined based on at least a concept coverage score of the second multimedia content and a relevance score of one or more of a set of pre-requisite concepts of the second multimedia content.

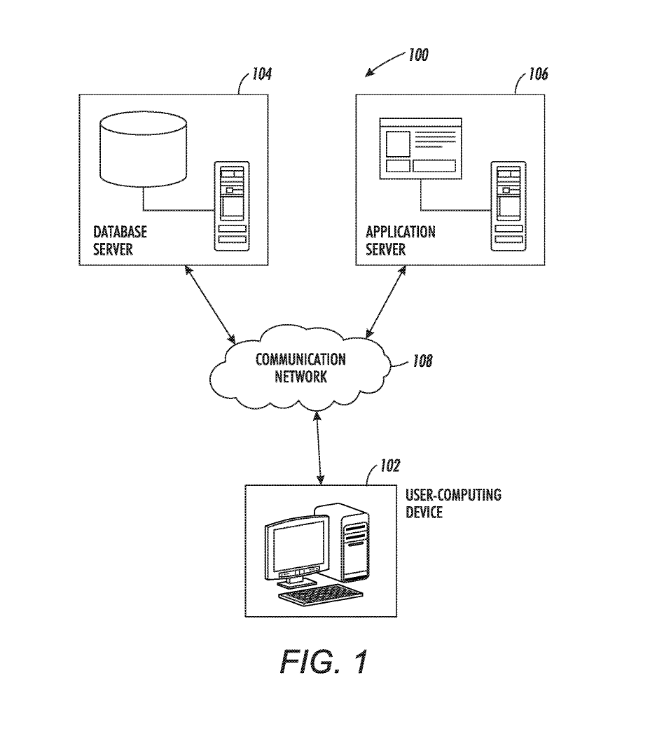

FIG. 1 is a block diagram that illustrates a system environment in which various embodiments of a method and a system may be implemented in accordance with at least one embodiment. With reference to FIG. 1, there is shown a system environment 100 that includes a user-computing device 102, a database server 104, an application server 106, and a communication network 108. The user-computing device 102, the database server 104 and the application server 106 may be communicatively coupled with each other over one or more communication networks, such as the communication network 108. For simplicity, FIG. 1 shows one user-computing device, such as the user-computing device 102, one database server, such as the database server 104, and one application server, such as the application server 106. However, it will be apparent to a person having ordinary skill in the art that the disclosed embodiments may also be implemented using multiple user-computing devices, multiple database servers, and multiple application servers, without deviating from the scope of the disclosure.

The user-computing device 102 may refer to a computing device (associated with a user) that may be communicatively coupled to the communication network 108. The user may correspond to an individual, such as a scholar, who may utilize the user-computing device 102 to transmit a request to the database server 104 or the application server 106 over the communication network 108. The request may correspond to one or more of a set of multimedia content of a course. In an embodiment, each of the set of multimedia content of the course is arranged in a pedagogical order that defines at least a sequence in which each of the set of multimedia content is to be inferred by the user to complete the course. The set of multimedia content may comprise at least a first set of multimedia content and a second set of multimedia content. In an embodiment, the first set of multimedia content and the second set of multimedia content in the set of multimedia content are determined based on at least one or more subject matters of the user's interest. Further, in an embodiment, one or more of the second set of multimedia content in the set of multimedia content follows after one or more of the first set of multimedia content in the set of multimedia content in the pedagogical order. In an embodiment, the request may further include one or more input parameters. The one or more input parameters may comprise the one or more subject matters of the user's interest, a time-related constraint associated with the user, and a preference of the user for one or more subject matters and associated pre-requisite subject matters.

The user-computing device 102 may include one or more processors in communication with one or more memory units. Further, in an embodiment, the one or more processors may be operable to execute one or more sets of computer-readable code, instructions, programs, or algorithms, stored in the one or more memory units, to perform one or more operations. In an embodiment, the user may utilize the user-computing device 102 to communicate with the database server 104 or the application server 106 over the communication network 108. In an embodiment, the user-computing device 102 may include hardware and/or software to display the pre-requisite subject matters.

The user-computing device 102 may be implemented as a variety of computing devices, such as a desktop, a computer server, a laptop, a personal digital assistant (PDA), a tablet computer, a mobile phone, a smartphone, and the like.

In an embodiment, the database server 104 may refer to a computing device or a storage device that may be communicatively coupled to the communication network 108. In an embodiment, the database server 104 may be configured to perform one or more database operations. Examples of the one or more database operations may include receiving/transmitting one or more queries, request, or multimedia content from/to one or more computing devices, such as the user-computing device 102 and/or the application server 106. The one or more database operations may further include processing and storing the one or more queries, request, or multimedia content.

In an embodiment, the database server 104 may be configured to retrieve the set of multimedia content from one or more data sources. Examples of the one or more data sources may include, but are not limited to, external databases, blogs, websites, and streaming servers that are managed by one or more institutions or organizations. In For example, an entity may use a computing device to upload the set of multimedia content associated with one or more courses to the database server 104. Examples of the entity may include, but are not limited to, an educational institution, an online video streaming service provider, a student, and a professor. In an embodiment, the database server 104 may be configured to receive a query from the application server 106 for the set of multimedia content of the course. Based on the received query, the database server 104 may retrieve set of multimedia content of the course from one or more data sources. Thereafter, the database server 104 may transmit the set of multimedia content to the application server 106 over the communication network 108.

Further, in an embodiment, the database server 104 may be configured to store the one or more sets of instructions, code, scripts, or programs that may be retrieved by the application server 106 to perform one or more operations. For querying the database server 104, one or more querying languages may be utilized, such as, but not limited to, SQL, QUEL, and DMX. In an embodiment, the database server 104 may be realized through various technologies such as, but not limited to, Microsoft® SQL Server, Oracle®, IBM DB2®, Microsoft Access®, PostgreSQL®, MySQL® and SQLite®, and/or the like.

A person having ordinary skill in the art will understand that the scope of the disclosure is not limited to the database server 104 as a separate entity. In an embodiment, the functionalities of the database server 104 may be integrated into the application server 106, or vice-versa, without deviating from the scope of the disclosure.

The application server 106 may refer to a computing device or a software framework hosting an application or a software service that may be communicatively coupled to the communication network 108. In an embodiment, the application server 106 may be implemented to execute procedures, such as, but not limited to, one or more sets of programs, instructions, code, routines, or scripts stored in one or more memory units for supporting the hosted application or the software service. In an embodiment, the hosted application or the software service may be configured to perform one or more operations of the application server 106.

In an embodiment, the application server 106 may be configured to transmit the query to the database server 104 to retrieve the set of multimedia content of the course based on the request received from the user-computing device 102. After retrieving the set of multimedia content of the course from the database server 104, the application server 106 may be configured to playback each multimedia content in the set of multimedia content in the pedagogical order through a media player, such as the Adobe® Flash Player. In another embodiment, the application server 106 may be configured to stream each multimedia content in the set of multimedia content in the pedagogical order on the user-computing device 102 over the communication network 108.

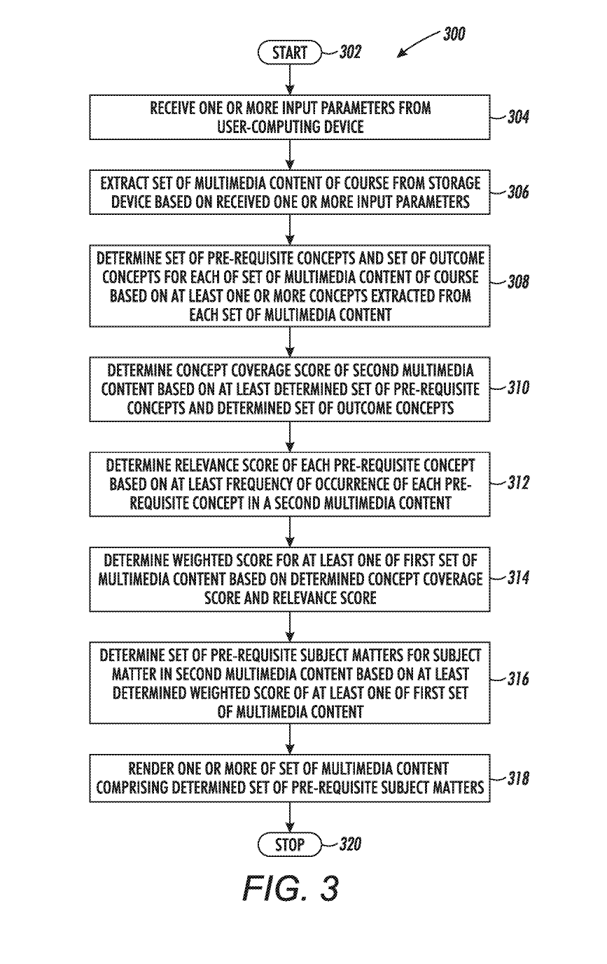

Prior to streaming of the set of multimedia content on the user-computing device 102, in an embodiment, the application server 106 may be configured to determine one or more subject matters and one or more concepts for each of the retrieved set of multimedia content. Further, the application server 106 may be configured to determine a set of pre-requisite concepts and a set of outcome concepts for each of the set of multimedia content of the course. Further, in an embodiment, the application server 106 may be configured to identify at least the first set of multimedia content and the second set of multimedia content in the retrieved set of multimedia content based on the one or more subject matters of user's interest in the received request. Further, the application server 106 may be configured to determine the concept coverage score of each second multimedia content in the second set of multimedia content. The concept coverage score is determined based on the determined set of pre-requisite concepts associated with the second multimedia content and the determined set of outcome concepts associated with at least one of the first set of multimedia content. Further, in an embodiment, the application server 106 may be configured to determine the relevance score of each pre-requisite concept that corresponds to the set of pre-requisite concepts. The relevance score of each pre-requisite concept is determined based on the frequency of occurrence of each pre-requisite concept in the second multimedia content. Further, in an embodiment, the application server 106 may be configured to determine the weighted score for at least the one of the first set of multimedia content based on the determined concept coverage score of the second multimedia content and the determined relevance score of one or more of the set of pre-requisite concepts of the second multimedia content. The determination of the weighted score has been explained in detail later in conjunction with FIG. 3.

Further, in an embodiment, the application server 106 may be configured to determine the set of pre-requisite subject matters for the subject matters in the second multimedia content based on the determined weighted score associated with at least the one of the first set of multimedia content. The determination of the set of pre-requisite subject matters for the subject matters in the second multimedia content has been explained in detail later in conjunction with FIG. 3.

After determining one or more of the set of multimedia content for each second multimedia content in the second set of multimedia content that may comprise the one or more subject matters of the user's interest, the application server 106 may render the one or more of the set of multimedia content on a user interface displayed on the display screen of the user-computing device 102. The determined one or more of the set of multimedia content are associated with the first set of multimedia content in the pedagogical order. In a scenario where one or more portions in the one or more of the set of multimedia content are associated with the one or more subject matters of the user's interest, the application server 106 may render a list of the one or more portions in the one or more of the set of multimedia content along with their corresponding time stamps. In another embodiment, the application server 106 may be configured to generate a targeted multimedia content based on the one or more portions in the one or more of the set of multimedia content that is associated with the one or more subject matters of the user's interest that may be rendered on the user-computing device 102.

The application server 106 may be realized through various types of application servers, such as, but are not limited to, a Java application server, a .NET framework application server, a Base4 application server, a PHP framework application server, or any other application server framework.

A person having ordinary skill in the art will appreciate that the scope of the disclosure is not limited to realizing the application server 106 and the user-computing device 102 as separate entities. In an embodiment, the application server 106 may be realized as an application program installed on and/or running on the user-computing device 102 without departing from the scope of the disclosure.

The communication network 108 may include a medium through which devices, such as the user-computing device 102, and servers, such as the database server 104, and the application server 106, may communicate with each other. Examples of the communication network 108 may include, but are not limited to, the Internet, a cloud network, a Wireless Fidelity (Wi-Fi) network, a Wireless Local Area Network (WLAN), a Local Area Network (LAN), a wireless personal area network (WPAN), a Wireless Local Area Network (WLAN), a wireless wide area network (WWAN), a cloud network, a Long Term Evolution (LTE) network, a plain old telephone service (POTS), and/or a Metropolitan Area Network (MAN). Various devices in the system environment 100 may be configured to connect to the communication network 108, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

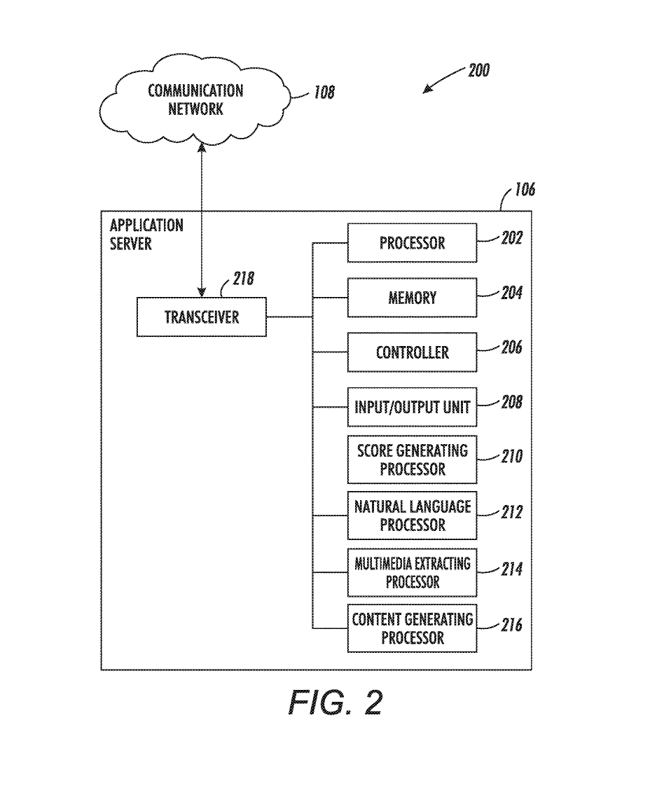

FIG. 2 is a block diagram that illustrates a system for content processing to determine pre-requisite subject matters from a first set of multimedia content for a subject matter in a second set of multimedia content, in accordance with at least one embodiment. With reference to FIG. 2, there is shown a system 200 that may include one or more processors, such as a processor 202, one or more memory units, such as a memory 204, one or more controllers, such as a controller 206, one or more input/output (I/O) units, such as I/O unit 208, one or more score generating processors, such as a score generating processor 210, one or more natural language processors, such as a natural language processor 212, one or more multimedia extracting processors, such as a multimedia extracting processor 214, one or more content generating processors, such as a content generating processor 216, and one or more transceivers, such as a transceiver 218.

The system 200 may correspond to a computing device, such as the user-computing device 102, or a computing server, such as the application server 106, without departing from the scope of the disclosure. However, for the purpose of the ongoing description, the system 200 corresponds to the application server 106.

The processor 202 comprises suitable logic, circuitry, interfaces, and/or code that may be configured to execute a set of instructions, programs, or algorithms stored in the memory 204 to perform the one or more operations. For example, the processor 202 may be configured to determine the set of pre-requisite concepts and the set of outcome concepts for each of the set of multimedia content of the course. The processor 202 may be configured to determine the set of pre-requisite subject matters from the first set of multimedia content for the subject matter in the second set of multimedia content. The processor 202 may be configured to determine a dependency between two or more of a plurality of multimedia content. In an embodiment, the processor 202 may be communicatively coupled to the memory 204, the controller 206, the input/output unit 208, the score generating processor 210, the natural language processor 212, the multimedia extracting processor 214, the content generating processor 216, and the transceiver 218. The processor 202 may be implemented based on a number of processor technologies known in the art. Examples of the processor 202 include, but not limited to, an X86-based processor, a Reduced Instruction Set Computing (RISC) processor, an Application-Specific Integrated Circuit (ASIC) processor, a Complex Instruction Set Computing (CISC) processor, and/or other processor.

The memory 204 may be operable to store one or more machine codes and/or computer programs having at least one code section executable by the processor 202, the controller 206, the I/O unit 208, the score generating processor 210, the natural language processor 212, the multimedia extracting processor 214, the content generating processor 216, and the transceiver 218. The memory 204 may store the one or more sets of instructions, programs, code, or algorithms that are executed by the processor 202, the controller, 206, the I/O unit 208, the score generating processor 210, the natural language processor 212, the multimedia extracting processor 214, the content generating processor 216, and the transceiver 218 to perform the respective one or more operations. Some of the commonly known memory implementations include, but are not limited to, a random access memory (RAM), a read only memory (ROM), a hard disk drive (HDD), and a secure digital (SD) card. In an embodiment, the memory 204 may include the one or more machine codes and/or computer programs that are executable by the processor 202, the controller 206, the I/O unit 208, the score generating processor 210, the natural language processor 212, the multimedia extracting processor 214, the content generating processor 216, and the transceiver 218 to perform the respective one or more operations. It will be apparent to a person having ordinary skill in the art that the one or more instructions stored in the memory 204 may enable the hardware of the system 200 to perform the one or more operations.

The controller 206 comprises suitable logic, circuitry, interfaces, and/or code that may be configured to at least control or regulate various operations between one or more internal components or one or more external components of the application server 106. The controller 206 may be communicatively coupled to the processor 202, the memory 204, the I/O unit 208, the score generating processor 210, the natural language processor 212, the multimedia extracting processor 214, the content generating processor 216, and the transceiver 218. The controller 206 may be a plug in board, a single integrated circuit on the motherboard, or an external device. Examples of the controller 206 may include, but are not limited to, a graphics controller, small computer system interface (SCSI) controller, network interface controller, memory controller, programmable interrupt controller, and/or terminal access controller.

The I/O unit 208 comprises suitable logic, circuitry, interfaces, and/or code that may be operable to facilitate the user to input the one or more input parameters. For example, the use may utilize the I/O unit 208 to input a name of the course, the one or more subject matters of interests, the time related constraints of the user, and so on The I/O unit 210 may be operable to communicate with the processor 202, the memory 204, the controller 206, the score generating processor 210, the natural language processor 212, the multimedia extracting processor 214, the content generating processor 216, and the transceiver 218. Further, in an embodiment, the I/O unit 208, in conjunction with the processor 202 and the transceiver 218, may be operable to transmit a recommendation of the one or more of the set of multimedia content comprising the determined set of pre-requisite subject matters for the one or more subject of user's interests. In an embodiment, such recommendation may be either in an audio form, a video form, a graphical form, or a text form. Examples of the input devices may include, but are not limited to, a keyboard, a mouse, a joystick, a touch screen, a microphone, a camera, and/or a docking station. Examples of the output devices may include, but are not limited to, a display screen and/or a speaker.

The score generating processor 210 comprises suitable logic, circuitry, interfaces, and/or code that may be configured to execute the one or more sets of instructions, programs, or algorithms stored in the memory 204 to perform the one or more operations. For example, the score generating processor 210 may be configured to determine the concept coverage score, the relevance score, and the weighted score. The determination of the concept coverage score, the relevance score, and the weighted score has been explained in detail later in conjunction with FIG. 3. The score generating processor 210 may be communicatively coupled to the processor 202, the memory 204, the controller 206, the I/O unit 208, the natural language processor 212, the multimedia extracting processor 214, the content generating processor 216, and the transceiver 218. The score generating processor 210 may be implemented based on a number of processor technologies known in the art. For example, the score generating processor 210 may be implemented using one or more of, but not limited to, an X86-based processor, a RISC processor, an ASIC processor, a CISC processor, and/or other such processor.

The natural language processor 212 comprises suitable logic, circuitry, interfaces, and/or code that may be configured to execute the one or more sets of instructions, programs, or algorithms stored in the memory 204 to perform the one or more operations. For example, the natural language processor 212 may be configured to determine the one or more subject matters associated with each of the extracted (or retrieved) set of multimedia content based on the processing of the audio and visual content associated with the extracted set of multimedia content. The natural language processor 212 may be communicatively coupled to the processor 202, the memory 204, the controller 206, the I/O unit 208, the score generating processor 210, the multimedia extracting processor 214, the content generating processor 216, and the transceiver 218. The natural language processor 212 may be implemented based on a number of processor technologies known in the art. For example, the natural language processor 212 may be implemented using one or more of, but not limited to, an X86-based processor, a RISC processor, an ASIC processor, a CISC processor, and/or other such processor.

The multimedia extracting processor 214 comprises suitable logic, circuitry, interfaces, and/or code that may be configured to execute the one or more sets of instructions, programs, or algorithms stored in the memory 204 to perform the one or more operations. For example, the multimedia extracting processor 214 may be configured to extract the set of multimedia content of the course from the storage device. In an embodiment, each of the extracted set of multimedia content of the course is arranged in a pedagogical order that defines the sequence in which each of the extracted set of multimedia content is to be inferred by the user to complete the course. The multimedia extracting processor 214 may be communicatively coupled to the processor 202, the memory 204, the controller 206, the I/O unit 208, the score generating processor 210, the natural language processor 212, the content generating processor 216, and the transceiver 218. The multimedia extracting processor 214 may be implemented based on a number of processor technologies known in the art. For example, the multimedia extracting processor 214 may be implemented using one or more of, but not limited to, an X86-based processor, a RISC processor, an ASIC processor, a CISC processor, and/or other such processor.

The content generating processor 216 comprises suitable logic, circuitry, interfaces, and/or code that may be configured to execute the one or more sets of instructions, programs, or algorithms stored in the memory 204 to perform the one or more operations. For example, the content generating processor 216 may be configured to generate the targeted multimedia content based on the content in the one or more of the set of multimedia content. The content generating processor 216 may be communicatively coupled to the processor 202, the memory 204, the controller 206, the I/O unit 208, the score generating processor 210, the natural language processor 212, the multimedia extracting processor 214, and the transceiver 218. The content generating processor 216 may be implemented based on a number of processor technologies known in the art. For example, the content generating processor 216 may be implemented using one or more of, but not limited to, an X86-based processor, a RISC processor, an ASIC processor, a CISC processor, and/or other such processor.

The transceiver 218 comprises suitable logic, circuitry, interfaces, and/or code that may be configured to receive/transmit the multimedia content or other information from/to one or more computing devices (e.g., the processor 202, the memory 204, the controller 206, the I/O unit 208, the score generating processor 210, the natural language processor 212, the multimedia extracting processor 214, and the content generating processor 216) over the communication network 108. In an embodiment, the transceiver 218 may implement one or more known technologies to support wired or wireless communication with the communication network 108. In an embodiment, the transceiver 218 may include, but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 218 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

FIG. 3 is a flowchart that illustrates a method for content processing to determine the pre-requisite subject matters from the first set of multimedia content for the subject matter in the second set of multimedia content, in accordance with an embodiment. With reference to FIG. 3, there is shown a flowchart 300 that is described in conjunction with FIG. 1 and FIG. 2. The method starts at step 302 and proceeds to step 304.

At step 304, the one or more input parameters are received from the user-computing device 102. The one or more input parameters may comprise the one or more subject matters associated with the second set of multimedia content that are of interest to the user, the time-related constraint associated with the user, and the preference of the user for the one or more subject matters and their associated pre-requisite subject matters. In an embodiment, the transceiver 218 may be configured to receive the one or more input parameters from the user-computing device 102 over the communication network 108. In an embodiment, the one or more input parameters may be transmitted along with the request for processing the set of multimedia content of the course to determine the one or more of the set of multimedia content that comprise at least one or more pre-requisite subject matters provided by the user.

Prior to transmitting the one or more input parameters, the user may utilize one or more input units of the user-computing device 102 to select at least one course from one or more courses pre-stored in a memory unit of the user-computing device 102. Each course may include the set of multimedia content (e.g., a set of audio content, a set of video content, a set of animation content, or a combination thereof) that are associated with the one or more subject matters of the course. Further, each of the set of multimedia content of the course may be in the pedagogical order that defines at least the sequence in which each of the set of multimedia content is to be inferred by the user to complete the course. The set of multimedia content of the course may be stored in a storage device, such as the memory unit of the user-computing device 102, memory 204, or the database server 104.

In cases where the sequence of multimedia content in the set of multimedia content is not present, the processor 202 may be further configured to determine the sequence of multimedia content in the set of multimedia content. The sequence of multimedia content in the set of multimedia content may be determined by use of an order of occurrence of words in a textbook to decide on the sequence. For example, let us assume a pair of lecture videos, say, “Lₐ” and “L_{b}.” The processor 202 may be configured to determine if “Lₐ” should appear before “L_{b}” or not in the sequence. The words present in “Lₐ” are “w₁^{a}, w₂^{a}, w₃^{a}, . . . , w_{M}^{a}” total “M” words). Similarly, the words present in “L_{b}” are “w₁^{b}, w₂^{b}, w₃^{b}, . . . , w_{N}^{b}” (total “N” words). For each of these words, the processor 202 may be configured to determine a mean occurrence in a relevant textbook, say “Oₘ^{a}” for “Lₐ” and “Oₙ^{b}” for “L_{b}.” Now for each pair of words from “Lₐ” and “L_{b},” {wₘ^{a}, wₙ^{b}}, processor 202 may check if the word from “Lₐ” appeared before the word from “L_{b}” in the textbook (only if both these words are present in the textbook). The processor 202 may utilize a pre-defined indicator variable “Iₘₙ” which is set as “+1” if the word from “Lₐ” appears before the word from “L_{b},” else is set as “−1.” Now if the processor 202 determines that Σ_{m,n} Iₘₙ is positive, then the processor 202 may determine that “Lₐ” is before “L_{b}.” However, if the processor 202 determines that Σ_{m,n} Iₘₙ is negative, then the processor 202 may determine that “Lₐ” is after “L_{b}.” Similarly, the processor 202 may determine the sequence of each multimedia content in the set of multimedia content. Based on the determined sequence, the processor 202 may identify the pedagogical order of the set of multimedia content.

In another embodiment, the user may utilize the user-computing device 102 to connect to a remote storage server, such as the database server 104, over the communication network 108 to select the course from the one or more courses. After selecting the course, the user may utilize the one or more input units of the user-computing device 102 to transmit the one or more input parameters to the transceiver 218 over the communication network 108. After receiving the one or more input parameters from the user-computing device 102, the transceiver 218 may store the received one or more input parameters in the storage device, such as the database server 104 or the memory 204.

At step 306, the set of multimedia content of the course is extracted or retrieved from the storage device, based on at least the received one or more input parameters. In an embodiment, the multimedia extracting processor 214 may be configured to extract or retrieve the set of multimedia content of the course from the storage device, such as the database server 104, memory 204, or the memory unit of the user-computing device 102, based on at least the received request comprising the one or more input parameters. For example, the multimedia extracting processor 214 may extract or retrieve the set of multimedia content from the storage device based on at least the course selected by the user.

In an embodiment, the multimedia extracting processor 214 may transmit a query to the storage device, such as the database server 104, memory 204, or the memory unit of the user-computing device 102, to extract or retrieve the set of multimedia content of the course. The multimedia extracting processor 214 may generate the query based on at least the selected course and/or the received one or more input parameters. After extracting the set of multimedia content of the course in the pedagogical order, the multimedia extracting processor 214 may further be configured to extract the one or more concepts in each of the extracted set of multimedia content. Prior to the extraction of the one or more concepts, the natural language processor 212 may be configured to determine the one or more subject matters associated with each of the extracted set of multimedia content. The natural language processor 212 may be configured to determine the one or more subject matters based on at least a processing of the audio content (i.e., speech-to-text transcript) and video content associated with each of the extracted set of multimedia content. Based on at least the processing of the audio content and the video content, the natural language processor 212 may be configured to segment each of the extracted set of multimedia content into one or more segments of multimedia content. In an embodiment, each of the one or more segments of multimedia content may correspond to the one or more subject matters. Thereafter, the natural language processor 212 may store the determined one or more subject matters of each of the extracted set of multimedia content in the storage device, such as the memory 204 or the database server 104.

A person having ordinary skill in the art will understand that the scope of the disclosure is not limited to the determination of the one or more subject matters of multimedia content based on the segmentation of the multimedia content. In an embodiment, the one or more subject matters of the multimedia content may be determined by use of one or more techniques known in the art without limiting the scope of the disclosure.

After determining the one or more subject matters of each of the extracted set of multimedia content, the multimedia extracting processor 214 may extract the one or more concepts from each of the extracted set of multimedia content based on at least one of the determined one or more subject matters and the one or more external knowledge databases (e.g., Wikipedia®). In an embodiment, the multimedia extracting processor 214 may utilize one or more techniques based on at least one or more of parts-of-speech (POS) tagging, text rank weighing, or usage analysis to extract the one or more concepts from each of the extracted set of multimedia content. Further, the multimedia extracting processor 214 may store the extracted one or more concepts corresponding to each of the extracted set of multimedia content in the storage device, such as the memory 204 or the database server 104.

At step 308, the set of pre-requisite concepts and the set of outcome concepts are determined for one or more of the extracted set of multimedia content of the course based on the one or more concepts extracted from each of the set of multimedia content. In an embodiment, the processor 202 may be configured to determine the set of pre-requisite concepts and the set of outcome concepts for the one or more of the extracted set of multimedia content of the course based on the one or more concepts extracted from each of the set of multimedia content. Further, in an embodiment, the set of pre-requisite concepts and the set of outcome concepts are determined by the use of the one or more external knowledge databases.

Prior to the determination of the set of pre-requisite concepts and the set of outcome concepts, the processor 202 may be configured to identify the one or more multimedia content from the extracted set of multimedia content. In an embodiment, the processor 202 may identify the one or more multimedia content from the extracted set of multimedia content based on the received one or more input parameters. For example, based on the one or more subject matters that are of interest to the user, the processor 202 may identify the one or more multimedia content from the extracted set of multimedia content. The identified one or more multimedia content may correspond to the second set of multimedia content. For each of the second set of multimedia content, one or more multimedia content in the extracted set of multimedia content that are preceding each of the second set of multimedia content in the pedagogical order may correspond to the first set of multimedia content. As discussed above, based on the received one or more input parameters, the processor 202 may identify the first set of multimedia content and the second set of multimedia content. Thus, the extracted set of multimedia content may comprise at least the first set of multimedia content and the second set of multimedia content, such that the second set of multimedia content follows the first set of multimedia content in the pedagogical order.

After identifying the first set of multimedia content and the second set of multimedia content, the processor 202 may be configured to determine the set of pre-requisite concepts and the set of outcome concepts for each of the second set of multimedia content and each of the first set of multimedia content, respectively. In an embodiment, the set of pre-requisite concepts of a second multimedia content that corresponds to the second set of multimedia content may be determined based on a set of extracted one or more concepts that are associated with the first set of multimedia content corresponding to the second multimedia content. Further, in an embodiment, the set of extracted one or more concepts comprises the extracted one or more concepts associated with the first set of multimedia content that shall be acquired, learned, or gained knowledge about in advance by the user prior to viewing of the second multimedia content. Similarly, in an embodiment, the set of outcome concepts of a first multimedia content corresponding to the second multimedia content may be determined based on a set of extracted one or more concepts or skills that may be acquired, learned, or gained knowledge about by the user after viewing or going through the first multimedia content. Similarly, the processor 202 may be configured to determine the set of pre-requisite concepts and the set of outcome concepts for each of the remaining multimedia content in the second set of multimedia content and the remaining multimedia content in the first set of multimedia content, respectively.

At step 310, the concept coverage score of the second multimedia content is determined based on the determined set of pre-requisite concepts associated with the second multimedia content and the determined set of outcome concepts associated with at least one of the first set of multimedia content corresponding to the second multimedia content. In an embodiment, the score generating processor 210 may be configured to determine the concept coverage score of the second multimedia content based on the determined set of pre-requisite concepts associated with the second multimedia content and the determined set of outcome concepts associated with at least one of the first set of multimedia content corresponding to the second multimedia content. In an embodiment, the concept coverage score may correspond to a score that is indicative of at least coverage of pre-requisite concepts of the second multimedia content that are covered based on the viewing of at least the first multimedia content.

In an exemplary scenario, the score generating processor 210 may utilize the following equation (denoted by equation-1) to determine the concept coverage score of a second multimedia content “i”:

$$γ ( i , j ) = \frac{\vert {P}_{i} ⋃ {O}_{j} \vert}{\vert {P}_{i} \vert} \qquad ( 1 )$$

where,

Pᵢ: corresponds to a set of pre-requisite concepts that is required to understand or read content in the second multimedia content “i” of the course;

Oⱼ: corresponds to a set of outcome concepts that are outcomes of having understood or read content in the first multimedia content “j” of the course; and

γ(i, j): corresponds to the concept coverage score of the second multimedia content “i” having understood or read content in the first multimedia content “j” of the course.

Similarly, the score generating processor 210 may utilize the above equation (denoted by equation-1) to determine the concept coverage score of the second multimedia content based on the determined set of pre-requisite concepts associated with the second multimedia content and the determined set of outcome concepts associated with the remaining first set of multimedia content corresponding to the second multimedia content. Further, the score generating processor 210 may utilize the above equation (denoted by equation-1) to determine the concept coverage score of the remaining second set of multimedia content.

A person having ordinary skill in the art will understand that the scope of the disclosure should not be limited to determine the concept coverage score of the second multimedia content based on the aforementioned equation (denoted by equation-1) and using the aforementioned techniques. Further, the examples provided in supra are for illustrative purposes and should not be construed to limit the scope of the disclosure.

At step 312, the relevance score of each pre-requisite concept is determined based on the frequency of occurrence of each pre-requisite concept in the second multimedia content. In an embodiment, the score generating processor 210 may be configured to determine the relevance score of each pre-requisite concept based on the frequency of occurrence of each pre-requisite concept in the second multimedia content. In an embodiment, the score generating processor 210 may further be configured to determine the relevance score of each pre-requisite concept based on at least the frequency of occurrence of each of the set of pre-requisite concepts associated with the second multimedia content.

In an exemplary scenario, the score generating processor 210 may utilize the following equation (denoted by equation-2) to determine the relevance score a pre-requisite concept “c” of the second multimedia content “i”:

$$α ( c , i ) = \frac{freq ( c , i )}{{Σ}_{x ∈ {P}_{i}} freq ( x , i )} \qquad ( 2 )$$

where,

freq(c, i): corresponds to a frequency of occurrence of the concept “c” in the second multimedia content“i.”

Similarly, the score generating processor 210 may utilize the above equation (denoted by equation-2) to determine the relevance score of each of the remaining set of pre-requisite concepts of the second multimedia content. Further, the score generating processor 210 may utilize the above equation (denoted by equation-2) to determine the relevance score of the remaining second set of multimedia content.

A person having ordinary skill in the art will understand that the scope of the disclosure should not be limited to determine the relevance score of each pre-requisite concept based on the aforementioned equation (denoted by equation-2) and using the aforementioned techniques. Further, the examples provided in supra are for illustrative purposes and should not be construed to limit the scope of the disclosure.

At step 314, the weighted score for the first multimedia content is determined based on the determined concept coverage score associated with the second multimedia content and the determined relevance score of one or more of the set of pre-requisite concepts associated with the second multimedia content. In an embodiment, the score generating processor 210 may be configured to determine the weighted score for the first multimedia content based on the determined concept coverage score associated with the second multimedia content and the determined relevance score of the one or more of the set of pre-requisite concepts associated with the second multimedia content. The one or more of the set of pre-requisite concepts correspond to one or more pre-requisite concepts that are common between the set of pre-requisite concepts of the second multimedia content and the set of outcome concepts of the first multimedia content corresponding to the second multimedia content.

In an exemplary scenario, the score generating processor 210 may utilize the following equation (denoted by equation-3) to determine the weighted score for the first multimedia content “j” with respect to the second multimedia content “i”:

wⱼᵢ=γ(i, j) (Σ_{c∈P}_{ᵢ}_{nO}_{ⱼ} α(c, i)) (3)

where,

wⱼᵢ corresponds to the weighted score.

Similarly, the score generating processor 210 may utilize the above equation (denoted by equation-3) to determine the weighted score of each of the remaining first set of multimedia content with respect to each of the second set of multimedia content.

A person having ordinary skill in the art will understand that the scope of the disclosure should not be limited to determine the weighted score for each of the first set of multimedia content based on the aforementioned equation (denoted by equation-3) and using the aforementioned techniques. Further, the examples provided in supra are for illustrative purposes and should not be construed to limit the scope of the disclosure.

At step 316, the set of pre-requisite subject matters for each of the one or more subject matters associated with each of the second set of multimedia content is determined based on at least the determined weighted score of each of the first set of multimedia content. In an embodiment, the processor 202 may be configured to determine the set of pre-requisite subject matters, for each of the one or more subject matters associated with each of the second set of multimedia content, based on the determined weighted score of each of the first set of multimedia content.

In an embodiment, the processor 202 may formulate an objective function in order to determine the set of pre-requisite subject matters for each of the one or more subject matters associated with each of the second set of multimedia content. Further, the processor 202 may compute a solution to the formulated objective function to so as to maximize the coverage of concepts of high relevance and minimize a count of the first set of multimedia content that may be required to be studied to understand the outcome concept of each of the second set of multimedia content. In an exemplary scenario, the processor 202 may solve the following objective function (denoted equation-4) to determine the set of pre-requisite subject matters for each of the one or more subject matters associated with each of the second set of multimedia content:

max Σ_{j<i} xⱼ {βwⱼᵢ−(1−β)} (4)

Subject to

$$∀ j < i , \frac{{\sum }_{k = 1}^{j - 1} {w}_{kj} {x}_{k}}{{\sum }_{k = 1}^{j - 1} {w}_{kj}} \geq β {x}_{j} , and ∀ j , {x}_{j} ∈ \{ 0 , 1 \}$$

where,

xⱼ=1 corresponds to lecture j is a pre-requisite for lecture i and xⱼ=0, otherwise; and

β corresponds to a tradeoff parameter between the number of pre-requisite multimedia content recommended and the pre-requisite concepts covered in the lecture i.

Further, in an embodiment, the processor 202 may be configured to determine a dependency between two or more of a plurality of the multimedia content that corresponds to the set of multimedia content based on the determined set of pre-requisite subject matters of each of the one or more subject matters associated with each of the second set of multimedia content.

At step 318, the one or more of the set of multimedia content comprising the determined one or more sets of pre-requisite subject matters are rendered. In an embodiment, the processor 202 may be configured to render the one or more of the set of multimedia content comprising the determined one or more sets of pre-requisite subject matters on a user interface displayed on the display screen of the user-computing device 102. In an embodiment, the determined set of pre-requisite subject matters may be based on the received one or more input parameters. The process ends at step 320.

In another embodiment, the content generating processor 216 may be configured to generate the targeted multimedia content based on content in the one or more of the set of multimedia content. The content may be extracted from the one or more of the set of multimedia content based on at least the received one or more input parameters and the determined one or more sets of pre-requisite subject matters. Further, the processor 202 may render the generated targeted multimedia content on the user interface displayed on the display screen of the user-computing device 102. The generated targeted multimedia content may correspond to multimedia content (i.e., a single audio, video, or animated content) that includes the content associated with at least: the one or more subject matters that are of interest to the user and the determined one or more sets of pre-requisite subject matters pertaining to the one or more subject matters.

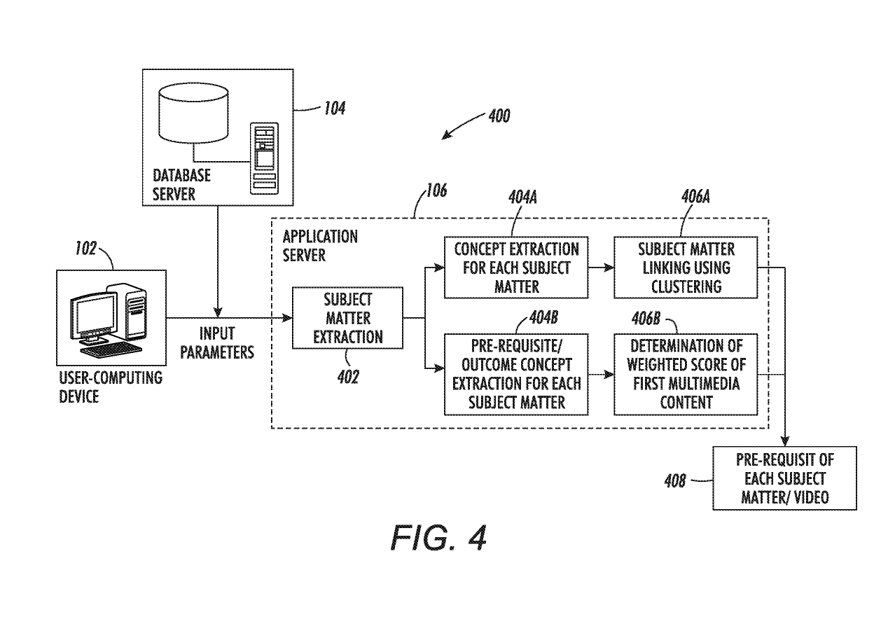

FIG. 4 is a block diagram that illustrates a flow diagram for content processing to determine pre-requisite subject matters from a first set of multimedia content for a subject matter in a second set of multimedia content, in accordance with at least one embodiment. With reference to FIG. 4, there is shown a block diagram 400 that has been described in conjunction with FIG. 1, FIG. 2, and FIG. 3.

In an embodiment, the transceiver 218 may be configured to receive one or more input parameters from the user-computing device 102. Further, the one or more input parameters may be stored in the database server 104. The one or more input parameters may comprise of one or more subject matters of the user interest that are associated with the second set of multimedia content, a time-related constraint associated with the user, and the preference of the user for one or more subject matters and for their associated pre-requisite subject matters. Thereafter, the multimedia extracting processor 214 may extract the set of multimedia content of the course from the database server 104, based on at least the received one or more input parameters (denoted by “402”). Further, the processor 202 may determine the set of pre-requisite concepts and the set of outcome concepts for the one or more of the extracted set of multimedia content of the course based on the one or more concepts extracted from each of the set of multimedia content (denoted by “404A”).

The processor 202 may identify the one or more multimedia content from the extracted set of multimedia content based on the received one or more input parameters. After identifying the first set of multimedia content and the second set of multimedia content, the processor 202 may determine the set of pre-requisite concepts and the set of outcome concepts for each of the second set of multimedia content and each of the first set of multimedia content, respectively (denoted by “404B”). The score generating processor 210 may determine the concept coverage score of the second multimedia content based on the determined set of pre-requisite concepts associated with the second multimedia content and the determined set of outcome concepts associated with at least one of the first set of multimedia content corresponding to the second multimedia content. Thereafter, the score generating processor 210 may determine the relevance score of each pre-requisite concept based on the frequency of occurrence of each pre-requisite concept in the second multimedia content (denoted by “406A”). The score generating processor 210 may determine the weighted score for the first multimedia content based on the determined concept coverage score associated with the second multimedia content and the determined relevance score of the one or more of the set of pre-requisite concepts associated with the second multimedia content, by use of an integer learning programming (ILP) formulation for maximizing the concept coverage and minimizing the number of pre-requisites (denoted by “406B”) in the set of multimedia content. The processor 202 may determine the set of pre-requisite subject matters, for each of the one or more subject matters associated with each of the second set of multimedia content, based on the determined weighted score of each of the first set of multimedia content (denoted by “408”).

Various embodiments of the disclosure encompass numerous advantages including method and system for content processing to determine the pre-requisite subject matters from the first set of multimedia content for the subject matter in the second set of multimedia content. In an embodiment, the method and system may be utilized to determine the set of pre-requisite concepts and the set of outcome concepts for each of the set of multimedia content of the course. The method and system may be utilized to determine the concept coverage score and the relevance score of each pre-requisite concept. Further, based on the concept coverage and relevance score, the processor may determine the weighted score for the first set of multimedia content. In an embodiment, the method and system may determine the set of pre-requisite subject matters for the subject matter in the second multimedia content. In an embodiment, the method and system may render the one or more of set of multimedia content on the user-computing device 102.

The disclosed method and system, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive, such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The system and method described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above method and system, or the numerous possible variations thereof.

Various embodiments of the method and system for content processing to determine pre-requisite subject matters from a first set of multimedia content for a subject matter in a second set of multimedia content. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person having ordinary skill in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for content processing, by a computing server, to determine pre-requisite subject matters from a first set of multimedia content for a subject matter in a second set of multimedia content, said method comprising:
determining, by a processor, a set of pre-requisite concepts and a set of outcome concepts for each of a set of multimedia content of a course based on at least one or more concepts extracted from each of said set of multimedia content, wherein said set of multimedia content comprise at least said first set of multimedia content and said second set of multimedia content;
for a second multimedia content that corresponds to said second set of multimedia content:
determining, by a score generating processor, a concept coverage score based on at least said determined set of pre-requisite concepts associated with said second multimedia content and said determined set of outcome concepts associated with at least one of said first set of multimedia content; and
determining, by said score generating processor, a relevance score of each pre-requisite concept that corresponds to said set of pre-requisite concepts based on at least a frequency of occurrence of said each pre-requisite concept in said second multimedia content;
determining, by said score generating processor, a weighted score for at least said one of said first set of multimedia content based on said determined concept coverage score of said second multimedia content and said determined relevance score of one or more of said set of pre-requisite concepts of said second multimedia content; and
determining, by said processor, a set of pre-requisite subject matters for said subject matters in said second multimedia content based on at least said determined weighted score associated with at least one of said first set of multimedia content.

2. The method of claim 1 further comprising extracting, by a multimedia extracting processor, said set of multimedia content of said course from a storage device, wherein each of said extracted set of multimedia content of said course is arranged in a pedagogical order that defines at least a sequence in which each of said extracted set of multimedia content is to be inferred by a user to complete said course.

3. The method of claim 2, wherein each of said second set of multimedia content in said extracted set of multimedia content follows after each of said first set of multimedia content in said extracted set of multimedia content in said pedagogical order.

4. The method of claim 3 further comprising determining, by a natural language processor, one or more subject matters associated with each of said extracted set of multimedia content based on at least a processing of an audio and visual content associated with each of said extracted set of multimedia content, wherein said one or more concepts are extracted based on said determined one or more subject matters.

5. The method of claim 1, wherein said set of pre-requisite concepts and said set of outcome concepts are further determined, by said processor, by use of one or more external knowledge databases.

6. The method of claim 1, wherein said relevance score of said each pre-requisite concept is further determined, by said score generating processor, based on at least a frequency of occurrence of each of said set of pre-requisite concepts associated with said second multimedia content.

7. The method of claim 1, wherein said one or more of said set of pre-requisite concepts correspond to one or more pre-requisite concepts that are common between said set of pre-requisite concepts of said second multimedia content and said set of outcome concepts of at least said one of said first set of multimedia content.

8. The method of claim 1 further comprising determining, by said processor, a dependency between at least a plurality of multimedia content that corresponds to said set of multimedia content based on at least said determined set of pre-requisite subject matters of said subject matter associated with each of said second set of multimedia content.

9. The method of claim 1 further comprising receiving, by a transceiver, one or more input parameters from a user computing device, associated with an user, over a communication network, wherein said one or more input parameters comprise at least one or more subject matters of said user interest that are associated with said second set of multimedia content, a time-related constraint associated with said user, and a preference of said user for one or more subject matters and for their associated pre-requisite subject matters.

10. The method of claim 9 further comprising rendering, by said processor, one or more of said set of multimedia content comprising said determined set of pre-requisite subject matters based on at least said received one or more input parameters.

11. The method of claim 9 further comprising generating, by a content generating processor, a targeted multimedia content based on at least content in one or more of said set of multimedia content, wherein said content is extracted from said one or more of said set of multimedia content based on at least said received one or more input parameters and said determined set of pre-requisite subject matters.

12. A system for content processing to determine pre-requisite subject matters from a first set of multimedia content for a subject matter in a second set of multimedia content, said system comprising:
a processor configured to determine a set of pre-requisite concepts and a set of outcome concepts for each of a set of multimedia content of a course based on at least one or more concepts extracted from each of said set of multimedia content, wherein said set of multimedia content comprise at least said first set of multimedia content and said second set of multimedia content;
for a second multimedia content that corresponds to said second set of multimedia content:
a score generating processor configured to:
determine a concept coverage score based on at least said determined set of pre-requisite concepts associated with said second multimedia content and said determined set of outcome concepts associated with at least one of said first set of multimedia content; and
determine a relevance score of each pre-requisite concept that corresponds to said set of pre-requisite concepts based on at least a frequency of occurrence of said each pre-requisite concept in said second multimedia content;
determine a weighted score for at least said one of said first set of multimedia content based on said determined concept coverage score of said second multimedia content and said determined relevance score of one or more of said set of pre-requisite concepts of said second multimedia content; and
said processor is further configured to determine a set of pre-requisite subject matters for said subject matter in said second multimedia content based on at least said determined weighted score associated with at least one of said first set of multimedia content.

13. The system of claim 12, wherein a multimedia extracting processor is configured to extract said set of multimedia content of said course from a storage device, wherein each of said extracted set of multimedia content of said course is arranged in a pedagogical order that defines at least a sequence in which each of said extracted set of multimedia content is to be inferred by a user to complete said course.

14. The system of claim 13, wherein each of said second set of multimedia content in said extracted set of multimedia content follows after each of said first set of multimedia content in said extracted set of multimedia content in said pedagogical order.

15. The system of claim 14, wherein a natural language processor is configured to determine one or more subject matters associated with each of said extracted set of multimedia content based on at least a processing of an audio and visual content associated with each of said extracted set of multimedia content, wherein said one or more concepts are extracted based on said determined one or more subject matters.

16. The system of claim 12, wherein said processor is further configured to determine said set of pre-requisite concepts and said set of outcome concepts by use of one or more external knowledge databases.

17. The system of claim 12, wherein said score generating processor is further configured to determine said relevance score of said each pre-requisite concept based on at least a frequency of occurrence of each of said set of pre-requisite concepts associated with said second multimedia content.

18. The system of claim 12, wherein said one or more of said set of pre-requisite concepts correspond to one or more pre-requisite concepts that are common between said set of pre-requisite concepts of said second multimedia content and said set of outcome concepts of at least said one of said first set of multimedia content.

19. The system of claim 12, wherein said processor is further configured to determine a dependency between at least a plurality of multimedia content that corresponds to said set of multimedia content based on at least said determined set of pre-requisite subject matters of said subject matters associated with each of said second set of multimedia content.

20. The system of claim 12, wherein a transceiver is configured to receive one or more input parameters from a user computing device, associated with an user, over a communication network, wherein said one or more input parameters comprise at least one or more subject matters of said user interest that are associated with said second set of multimedia content, a time-related constraint associated with said user, and a preference of said user for one or more subject matters and for their associated pre-requisite subject matters.

21. The system of claim 20, wherein said processor is further configured to render one or more of said set of multimedia content comprising said determined set of pre-requisite subject matters based on at least said received one or more input parameters.

22. The system of claim 20, wherein a content generating processor is configured to generate a targeted multimedia content based on at least content in one or more of said set of multimedia content, wherein said content is extracted from said one or more of said set of multimedia content based on at least said received one or more input parameters and said determined set of pre-requisite subject matters.

23. A computer program product for use with a computer, said computer program product comprising a non-transitory computer readable medium, wherein said non-transitory computer readable medium stores a computer program code for content processing to determine pre-requisite subject matters from a first set of multimedia content for a subject matter in a second set of multimedia content, wherein said computer program code is executable by one or more processors in a computing device to:
determine a set of pre-requisite concepts and a set of outcome concepts for each of a set of multimedia content of a course based on at least one or more concepts extracted from each of said set of multimedia content, wherein said set of multimedia content comprise at least said first set of multimedia content and said second set of multimedia content;
for a second multimedia content that corresponds to said second set of multimedia content:
determine a concept coverage score based on at least said determined set of pre-requisite concepts associated with said second multimedia content and said determined set of outcome concepts associated with at least one of said first set of multimedia content; and
determine a relevance score of each pre-requisite concept that corresponds to said set of pre-requisite concepts based on at least a frequency of occurrence of said each pre-requisite concept in said second multimedia content;
determine a weighted score for at least said one of said first set of multimedia content based on said determined concept coverage score of said second multimedia content and said determined relevance score of one or more of said set of pre-requisite concepts of said second multimedia content; and
determine a set of pre-requisite subject matters for said subject matters in said second multimedia content based on at least said determined weighted score associated with at least one of said first set of multimedia content.
